(19) United States
(12) Patent Application Publication
(10) Pub. No.: US 2019/0279084 A1
(43) Pub. Date: Sep. 12, 2019

(54) System and method for element detection and identification of changing elements on a web page

(71) Applicants: Adi Darachi, JR., Tel-Mond (IL); Dan Kotlicki, Netanya (IL)

(72) Inventors: Adi Darachi, JR., Tel-Mond (IL); Dan Kotlicki, Netanya (IL)

(73) Assignee: Toonimo, Inc., New York, NY (US)

(21) Appl. No.: 15/998,825

(22) Filed: Aug. 15, 2018

Related U.S. Application Data
(60) Provisional application No. 62/545,821, filed on Aug. 15, 2017.

(51) Int. Cl. G06N 3/08; G06F 16/958

(52) U.S. Cl. CPC G06N 3/08; G06F 16/986

(57) ABSTRACT

A system and method to identify and detect a particular element on a webpage that may have changed some of its attributes. Machine-learning is used in the form of a neural network to detect differences between elements. This avoids the problem of having to have a different neural network for each element of interest. The present invention is able to detect and identify an element from the point of view of a human viewer, and then recognize that a somewhat changed version of the element appearing on a different page or on the same page at a different time is really the known element.

This application is related to, and claims priority from, U.S. Provisional Patent Application No. 62/545,821 filed Aug. 15, 2017. Application 62/545,821 is hereby incorporated by reference in its entirety.

### BACKGROUND

### Field of the Invention

The present invention relates to identification of elements of a web page and more particularly to a system and method to identify and detect a particular element that may have changed some of its attributes.

### Description of the Problem Solved

Web pages and web sites in general are composed of a large number of smaller elements. An element can be a portion of text, a picture or photograph, an other type of graphic, a portion of the screen where data can be enter, a link, a background or any other type of static or dynamic entity that can be displayed on the screen.

Web pages are typically described in a language known as html (Hypertext Markup Language) at the level of page display (even though pages and sites may be developed and deployed in different languages and by different tools). The html version of a web page is the level that is transmitted from a server to a client computer over a network where it is displayed by a program on the client computer known as a browser.

An element is an entity that typically can be identified by a human viewer even if it is slightly changed. For example, of the font of a text box is changed, a human can recognize that it is the same element. If a photo is repositioned to a different location on the screen, a human can immediately find and identify the element.

It would be very desirable in a variety of fields of endeavor to be able to detect and identify an element from the point of view of a human viewer, and then be able to recognize that a somewhat changed version of the element appearing on a different page or on the same page at a different time is really the known element.

Each element on a page has a set of html attributes that describe how it should be displayed including, among many others, the attributes of size and location on the screen. Prior art systems identify an element simply by the collection of its html attributes, or by a particular subset of its attributes. However, this can lead to unsatisfactory results since the set of attributes can change significantly for different representations of the same element.

It would be advantageous to assign an identification to an element that is not simply based on its html attributes alone, but rather using artificial intelligence to attempt to identify an element as a human would, namely by its overall appearance. This way, if the element is moved to a different position, resized, re-colored, or uses a different font, it can be detected and identified as the same element.

### SUMMARY OF THE INVENTION

The present invention represents a system and method for detecting and identifying a previously known element when some of its attributes have changed. Machine-learning is used in the form of a neural network or other machine learning system to detect differences between elements. This avoids the problem of having to have a different neural network for each element of interest.

Potential elements for a match of a known element are: 1) one of the selectors matches, 2) one or more of the attributes match, 3) the element is located in the same position, 4) the content (text, graphic) inside the element is the same.

The present invention generally requires more than one condition to match. In a search of a web page for a known element, a set of candidate elements appearing on that page is returned. If the set is reasonably small, a probability for each candidate is returned. If the probability exceeds a predetermined threshold, a match can be declared.

The present invention “understands” differences between two elements. Instead of presenting the problem in the form of “given these attributes, what is the probability that this is the same element”, the present invention asks the question “given the differences between the candidate element and the known element, what is the probability that this is the same element.” This avoids the problem of multiple neural networks (NN). The present invention teaches one NN which element's differences are usually considered SIMILAR or NOT SIMILAR.

### DESCRIPTION OF THE FIGURES

Attention is now directed to several drawings that illustrate features of the present invention.

FIGS. 1-5 depict three tables of HTML attributes, namely HTML element attributes, HTML style attributes and additional custom attributes.

FIG. 6 is a block diagram of an embodiment of the present invention. FIG. 7 shows user screens.

Several figures and illustrations have been provided to aid in understanding the present invention. The scope of the present invention is not limited to what is shown in the figures.

### DESCRIPTION OF THE PREFERRED EMBODIMENTS

The present invention relates to a utility that helps users identifying web page elements by their look and content in a manner a human would decide. Human perception of similarity is accomplished by the visual representation of the element, While the ‘browser’ expects specific attributes (chosen by the developer) to consider an element as “similar. The present invention attempts to imitate human perception for element similarity with the following steps:

When choosing element, information regarding the element is collected in order to later choose the potential elements, and to query a Neural network (NN)) to make the predication as accurate as possible.

The Problems with the Prior Art:

In order to identify DOM elements on a loaded html page, usually either a css selector or the elements XPath is used in the prior art. Css/jquery selector:—Some advanced platforms backend systems build and return their elements with different selection attributes on each page load or each user that loads the page. [Note: a DOM element is a Document object model. The DOM is the way Javascript sees its containing pages' data. It is an object that includes how the HTML/XHTML/XML is formatted, as well as the browser state].

For example, a server side developer decides to construct the ‘id’ fields (the ‘id is considered as a very “strong” selector) of a certain module with a prefix of the users’ unique system identifier. So every user that logs in will receive a different ‘id’ attribute. When a page's content is slightly changed, or if there is a change of design or layout, or if different dynamic content is loading onto the page, the detection of the element the system is looking for is changed. The XPath that the system initially “captured” will not necessarily point to the same element.

Because of the problems named above with using one type of selector, some companies/competitors that need to detect elements to later on match them at runtime developed algorithms that take more than one identifier, and by using a weighted calculation and thresholds, they try and detect the element. An editor can sometimes enter/insert a preference to one identifiers/selector instead of the other.

Other problems may occur with responsive design and detecting an element across different resolutions or with a slight text or page's structure change.

### The Process

### High Level:

1. Getting potential candidate elements

Potential are candidate elements are elements that match at least one of the following conditions:
Selector—one of the selectors matches.
Attributes—one of the attributes matches.
Position—The element is located in the same place.
Content—the content (Text inside the element) matches.

To overcome performance issues, the system ignores potential candidate elements that match only one condition—the typical philosophy of the present invention is that if the element is the “correct” element, it should return by more than one condition as a candidate element; furthermore, the system will not accept elements that return more than a predetermined number of candidate elements (such as 15 in some embodiments).
2. Calculating the difference

The present invention generates a neural network (NN) that “understands” differences between two elements, and avoids a solution that would require a neural network “per element”. Instead of asking the NN “Giving these attributes, what is the probability that this is the same element?”—which would require a NN per element since the machine would need to be trained on what “this element” refers to for each element, the system asks the NN “Given these differences, what is the probability that this is the target element.” The system teaches ONE machine which elements' differences are usually considered SIMILAR or NOT-SIMILAR instead of asking questions regarding a specific element which will require teaching the machine on each specific element.
3. Getting scores: The system passes the element differences to the NN, which results a prediction of the probability that the candidate element is similar to the target element. The system filters out candidate elements with a probability lower than 50%. The system then typically picks the element with the highest probability.
4. Action flow:

### System Side

The invention trains the machine learning algorithm to “understand” what the odds are that two elements are the same element, even if some things change in the elements.

A client administrator enters the system editor to create a walkthrough. He chooses elements on the screen to attach an “action” (text bubbles, visual coach-marks, highlights, or any other visual action) element to (to be target elements). The system captures information from the elements and saves it. An end-user receives a codeline, and retrieves the rule engine and all the files along with the machine learning trained result set and weighted nodes from the trained set. The end-user runs the walkthroughs.

### Client Side

1. The system searches all elements using all selectors that can might match the element, thus returning an array of candidates that might be the element.
2. The system passes a combination of the original definition of the element along with each real-time candidate element to the machine learning algorithm which returns the probability that these two elements are the same element.
3. By using a combination of a threshold, and the element that receives the highest probability, the system chooses the candidate element as being the target element.

### Technical Level:

The system gathers attributes regarding the state of the browser such as:
1.Current resolution (Viewport dimensions).
2.Attributes about the visual appearance of the element such as:
1.It's dimensions (width and height).
2.The element offset.
3. The element position in the screen or relative to it's parents.
4. Attributes:
   Style attributes such as:-‘width’, ‘height’, ‘position’, ‘display’, ‘overflow’, ‘visibility’, ‘text-decoration’, ‘border’, ‘background’, ‘background-color’, ‘color’, ‘font’, ‘font-family’, ‘font-size’, ‘opacity’, ‘box-sizing’, ‘border-radius’, ‘transform’, ‘float’, ‘margin’, ‘padding’, ‘top’, ‘left’, ‘right’, ‘bottom’.
   System html attributes such as-“accept”, “accept-charset”, “accesskey”, “action”, “alt”, “async”, “autocomplete”, “autofocus”, “autoplay”, “challenge”, “charset”, “checked”, “cite”, “class”, “cols”, “colspan”, “content”, “contenteditable”, “contextmenu”, “controls”, “coords”, “data”, data_*, “datetime”, “default”, “defer”, “dir”, “dirname”, “disabled”, “download”, “draggable”, “dropzone”, “enctype”, “for”, “form”, “formaction”, “headers”, “height”, “hidden”, “high”, “href”, “hreflang”, “http—equiv”, “id”, “ismap”, “keytype”, “kind”, “label ”, “lang”, “list”, “loop”, “low”, “max”, “maxlength”, “media”, “method”, “mm”, “multiple”, “muted”, “name”, “novalidate”, “onabort”, “onafterprint”, “onbeforeprint”, “onbeforeunload”, “onblur”, “oncanplay”, “oncanplaythrough”, “onchange”, “onclick”, “oncontextmenu”, “oncopy”, “oncuechange”, “oncut”, “ondblclick”, “ondrag”, “ondragend”, “ondragenter”, “ondragleave”, “ondragover”, “ondragstart”, “ondrop”, “ondurationchange”, “onemptied”, “onended”, “onerror”, “onfocus”, “onhashchange”, “oninput”, “oninvalid”, “onkeydown”, “onkeypress”, “onkeyup”, “onload”, “onloadeddata”, “onloadedmetadata”, “onloadstart”, “onmousedown”, “onmousemove”, “onmouseout”, “onmouseover”, “onmouseup”, “onmousewheel ”, “onoffline”, “ononline”, “onpageshow”, “onpaste”, “onpause”, “onplay”, “onplaying”, “onprogress”, “onratechange”, “onreset”, “onresize”, “onscroll ”, “onsearch”, “onseeked”, “onseeking”, “onselect”, “onshow”, “onstalled”, “onsubmit”, “onsuspend”, “ontimeupdate”, “ontoggle”, “onunload”, “onvolumechange”, “onwaiting”, “onwheel ”, “open”, “optimum”, “pattern”, “placeholder”, “poster”, “preload”, “readonly”, ‘re!“, “required”, “reversed”, “rows”, “rowspan”, “sandbox”, “scope”, “scoped”, “selected”, “shape”, “size”, “sizes”, “span”, “spellcheck”, “src”, “srcdoc”, “srclang”, “srcset”, “start”, “step”, “style”, “tabindex”, “target”, “title”, “translate”, “type”, “usemap”, “value”, “width”, “wrap”
   The system marks with higher relevance system attributes such as-“class”, “style”, “width”, “height”, “type”, “disabled”, “checked”, “alt”, “title”, “value”, “src”, “href’, “id”, “name”, “placeholder”, “required”, “disabled”.
5. Custom Attributes—Attributes that was implemented by the website owner
6. Resolution—The resolution that the sample was taken in.
7. tagNamePath—Path of the parent-element tagName till the documentElement
8. contentFirstLevelStructure—String representing the first level structure of the element's content
9. contentDeep Structure—String that represent the deeper levels of struture.
10. indexPathParent—String that represent the index of each parent in it's parent.
11. contentHTML—the content of the element in HTML form.
12. uniqueSelector—Unqiue cϵϵ selector to the element.
13. absoluteSelector—Absolute css selector the element.
14. uniqueSoftXPathTo—Unique Xpath non-id selector to the element.
15. uniqueHardXPathTo—Unique Xpath selector to the element.
16. absoluteXpathSelector—Absolute Xpath selector.
17. indexinParent—The index of the element in it's parents
18. tagName—The tagName of the element.
19. contentText—The content of the element.
20. contentTextMatcher—Sample of the first 20 letters of ‘contentText’ for better performance.
21. positionMathcer—position of the element, relative to the first not-static parent (will be converted to Boolean).
22. offset—The position of the element relevant to the entire page.
23. Element tag name (Can be Div, A—anchor, Span, hi, h2 etc.).
24. The text content inside the element—The text inside the element (without markup language)+because this might be very long; can also take the initial X (20 for example) characters for comparison.

The Element Identifier” consists of the following main components:

| NAME | DESCRIPTION |
|---|---|
| NN model (Machine- | Mutilayer perceptron designed to |
| learning algorithm) | identify differences between |
| | samples. |
| Identification object | An algorithm that generates an array |
| | that represents the distance or |
| | differences between two |
| | ‘Identification objects” |
| | (samples). |
| Identification Diff | A diff object generated by two |
| Object | samples, usually an old sample and a |
| | sample we want to measure (query) for |
| | probability to be the same element. |
| Biasing algorithm | An attribute/feature that helps the |
| | NN priorities position over content |
| | or the other way around, if a walk- |
| | through creator’ prefers to |
| | ignore one of which. |
| Caching algorithm | An algorithm that reduce the number |
| | of DOM and NN queries to improve |
| | performance by caching previous |
| | results. |
| Identification object | An algorithm that generates the |
| generator (Sampling | identification object', a set of |
| Algorithm) | properties that describes the |
| | elements style and structure in |
| | the DOM. |

Machine-Learning Algorithm

In order to predict the probability of two samples to represent the same element the present invention can use a multi-layer perception neural network (MLP NN).

The element Identifier is a classification algorithm that is built to receive a difference “diff” object which is a product of the distance between two elements-samples as the input, and outputs the probability of the two elements to be the same element.

The model is trained with both data generated by real-users as well as data generated by automation scripts.

### Identification Object Generator (Sampling Algorithm)

In order to identify an element in the future, the system generates a sample that is combined with both information regarding the style/display of the element and its position and structure in the nom.

This sample will later (when the system wants to check for the probability of an element to be the same as the sample) will be used to produce a diff object (Identificatinn Diff object) that can be used to query the NN.

When sampling an element, the “Element Identifier” looks for elements with similar structure in its ancestors in the DOM.

In case multiple elements are detected with the same structure, it is required to provide an element ‘preference’ (Value other then AUTO for the Biasing algorithm) (For more info please read—Biasing algorithm below).

### Identification Diff Object

The “diff” object is the product of calculating the distance (edit distance [physical separation on page, font difference, etc.], color distance, numeric distance) between to identification object samples. These basically represent the distance between the elements, or how different they are from each other.

### List of Value Type and Distance Measurements Methods

String (that result as Boolean): Checking whether the values are similar (comparison). String (that result as distance): Checking the distance between the element (Levenshtein distance, sift4).

color (distance): distance between colors (dE76, dE94, CMC 1:c, dEOO).

Number (that result as Boolean): Checking whether the values are similar (comparison).

Number (that result as distance): the distance between the values.

### The Results are Normalized as Follows:

Distance—values are normalized using hyperbolic tangent.

Boolean—values are normalized to −1 and 1.

The Following are the Algorithms used for each Calculation Type:

| Type | Algorithm |
|---|---|
| Edit Distance | Levenshtein distance, sift4 |
| Color Distance | dE76, dE94, CMC I: c, dEOO |
| Numeric Distance | Simple numeric subtraction |
| Number/String | Simple Boolean comparison |

### Biasing Algorithm

It is very common for a page in a website to have multiple elements that share the same appearance and element structure (e.g. navigation menu, table structure, tails layout).

Trying to detect such elements results in the following issues:
The NN algorithm might choose the wrong element when the page is being changed (Elements' reaction to user behaviors, such as ‘hover’ ‘click’ etc. .)
The NN algorithm might choose the wrong element when the environment is being changed (different resolution, page-state, or minor changes in the structure of the DOM)
To solve the issues above, an additional “attribute” with states is used to provide the NN with a ‘clue’ on which properties should have a greater weight.

Biasing Attribute States:
Auto—Don't bias, let the algorithm try its best without a “clue”
Position—Bias in the favor of the position, treat position attributes (such as the position of the item in the list) with greater weight
Content—Bias in the favor of the content, treat the content attributes (such as the text in the element etc) with greater weight

### Caching Algorithm

I he identification process using the “Element Identifier” is about 10-30 costly (in terms of performance) and due to that, takes longer then the average element querying using the browser API (with the function document[getElementById/QuerySelector]).

To solve this performance issue and to minimize the performance differences between the “Element Identifier” and the native browser behavior, the present invention uses caching algorithm.

The caching algorithm tries to reduce the usage of NN and normalize as possible by generating a unique Id consists of it's current ‘Sample object’.

### Identification Object

The “Identification object” is a JSON object that describes an HTML element in its a current state (current browser, current resolution, current attributes etc). [Note: a JSON (JavaScript Object Notation) is a lightweight data-interchange format that is easy for humans to read and write]. It is easy for machines to parse and generate. This element's JSON object, is later used in real time, on an end-user's machine while executing the detection algorithm, to compare and determine the probability that a different sample element is indeed the same element.

Composing the “Identification object” requires first overcoming the differences in the value of some properties between browsers and browser versions.

To address the issue of differences between browsers and browser versions, the sampling algorithm is ‘normalizing’ all values based on their type. (Color, String, Number)

Below is a list of all the properties used by the “element identifier” and the way it is normalized and the way the diff object is created when comparing two objects.

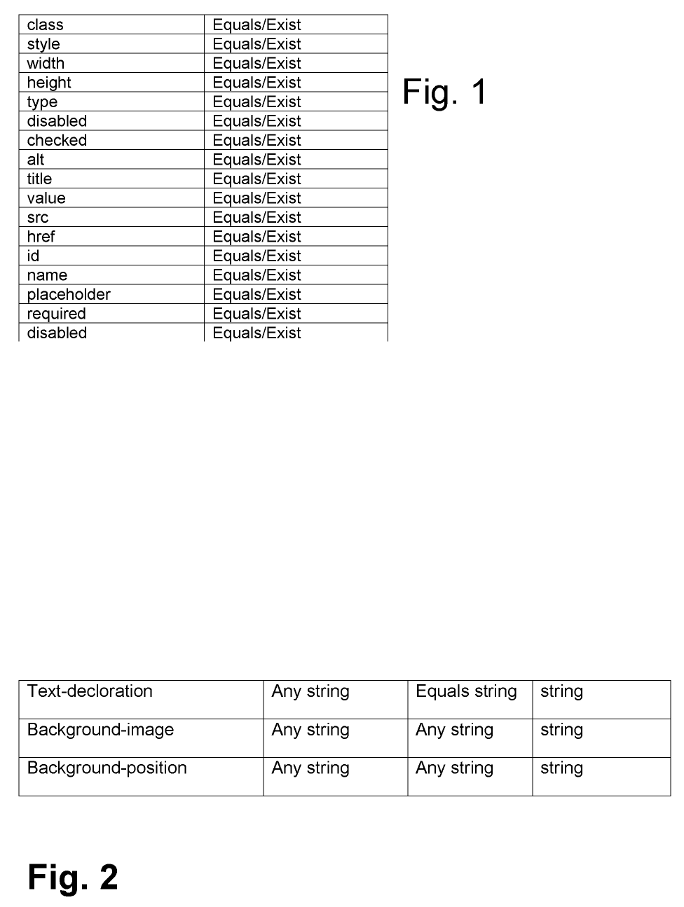

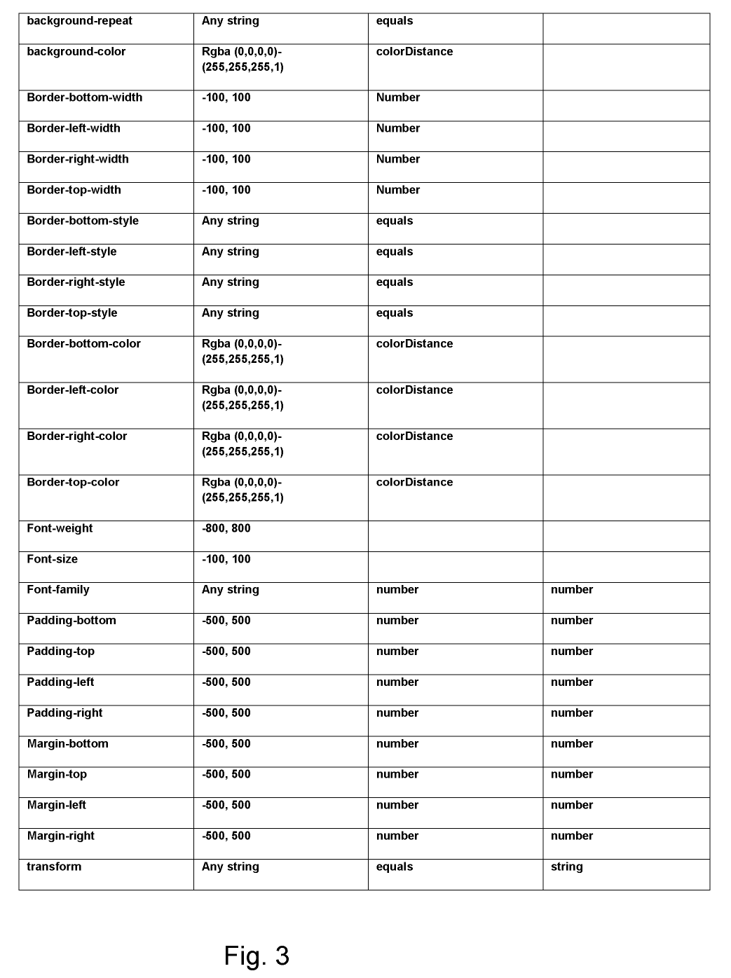

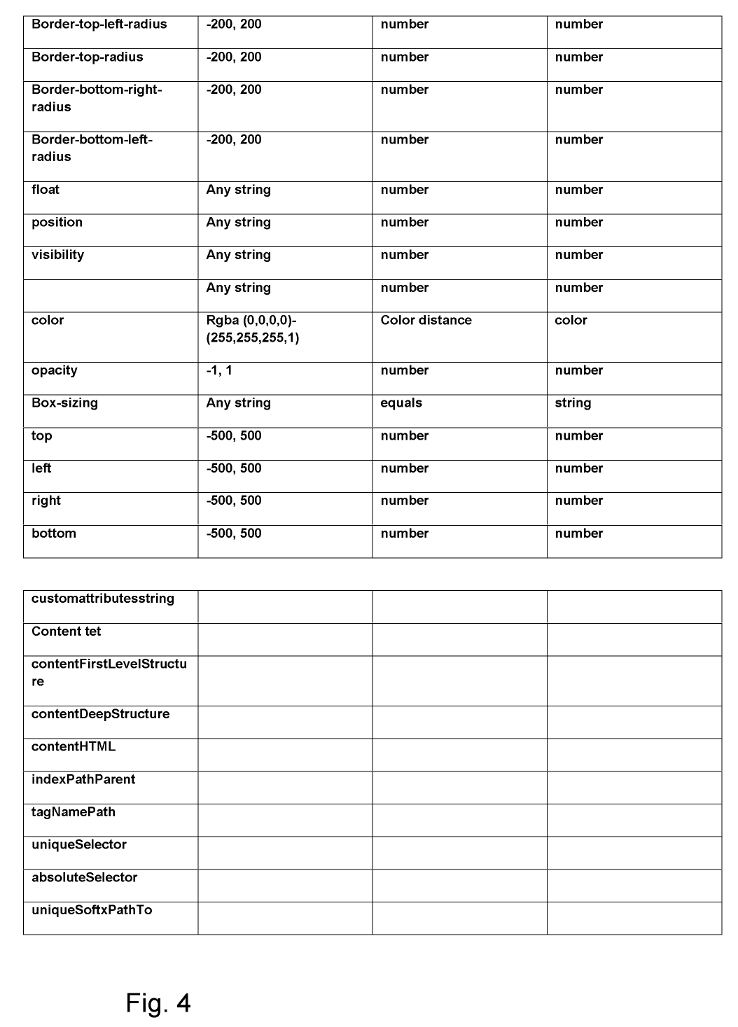

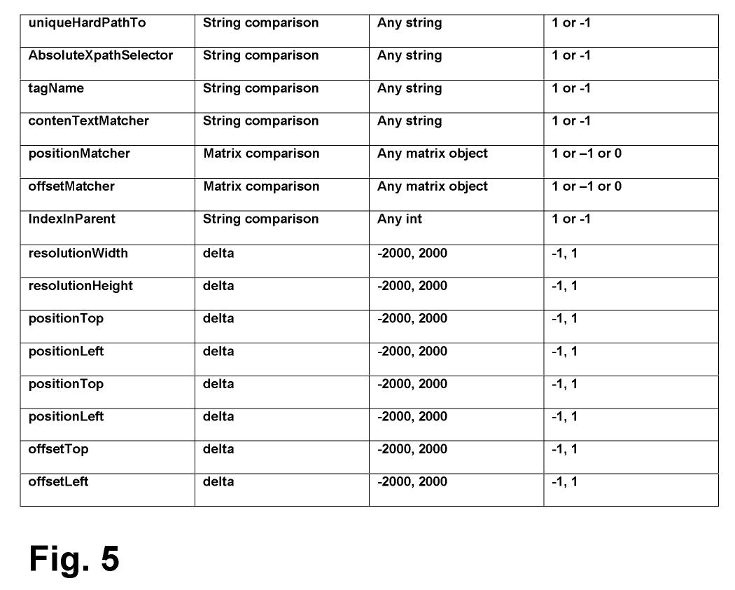

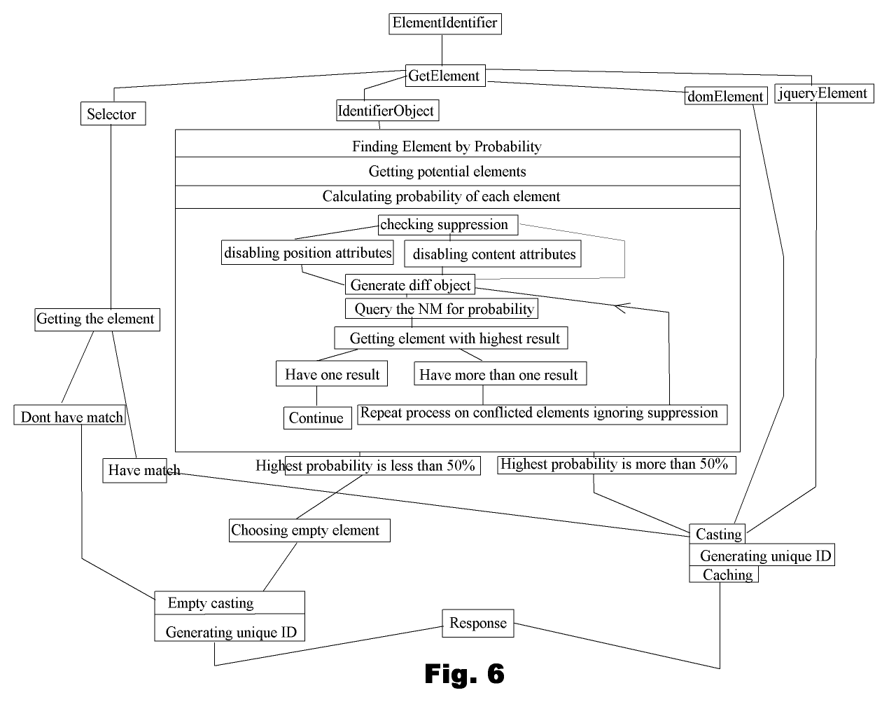

The three tables (HTML element attributes, HTML style attributes and additional custom attributes) represented by FIGS. 1, FIG. 2, FIG. 3, FIG. 4 and FIG. 5 detail the properties of the element identification object.

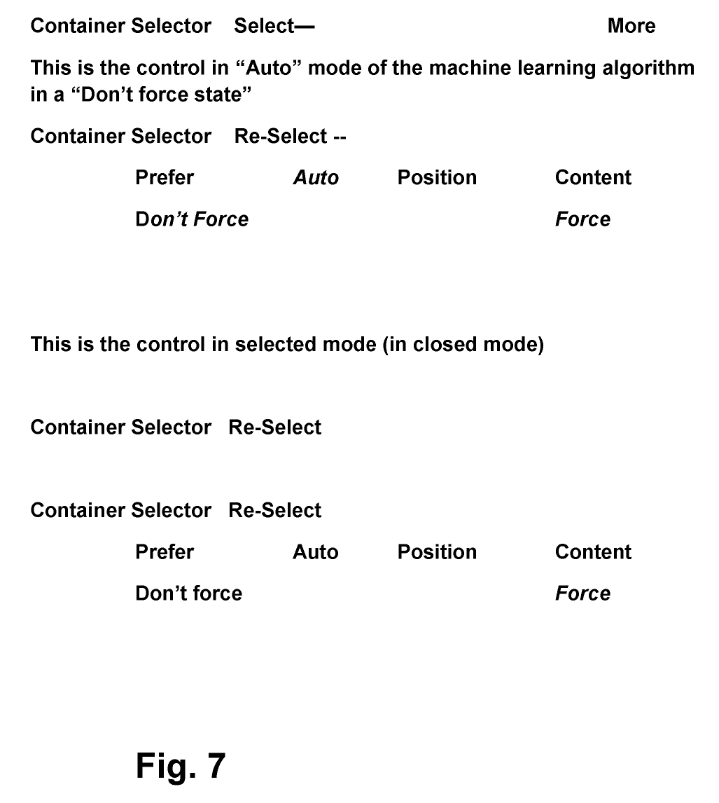

FIG. 6 shows a block diagram of system operation.

When an end user watches a walkthrough, and the system needs to attach a visual/button/text bubble/any other element to an existing element or to the HTML, the system uses algorithms to deflect the number of elements it passes to the machine learning algorithm to reduce performance issues.

The system checks multiple selectors such as:
‘unique Selector’, ‘ab soluteSelector’, ‘uniqueSoftXPathTo’, ‘uniqueHardXPathTo’, ‘ab soluteXpathSelector’, ‘contentTextMatcher’, ‘positionMatcher’
To get all the element this might return.

The system then iterates on all the candidate elements, and for each candidate element it normalizes the difference between the current iteration element attributes and the original target element's attributes (that were taken through the editor) to values that it can pass to the machine learning algorithm or NN.

//Custom attributes
customAttributesString:
Normalize. stringTo. editDistanceTanhRange (JSON. stringify (a. customAttribu tes),
JSON.stringify(b.customAttributes)),
//Content attributes
contentText: Normalize.stringTo.sift4TanhRange(a, b, TcontentTextT)
contentFirstLevelStructure:
Normalize. stringTo. sift4TanhRange (JSON. stringify (a. contentFirstLevelStr ucture),
JSON.stringify(b.contentFirstLevelStructure) ), //distance between strings
contentDeepStructure:
Normalize. stringTo. sift4TanhRange (JSON. stringify (a. contentDeepStructure ),
JSON.stringify(b.contentDeepStructure) ), //distance between strings
contentHTML: Normalize.stringTo.sift4TanhRange(a, b, ‘contentHTML’), //distance
between strings
indexPathParent: Normalize.stringTo.sift4TanhRange(a, b, TindexpathparentT) ,
//distance between strings
//Binary data
tagNamePath: Normalize.stringTo.binary(a, b, ^{T}tagNamePath^{T}), uniqueSelector:
Normalize.stringTo.binary(a, b, TuniqueselectorT), absoluteSelector:
Normalize.stringTo.binary(a, b, TabsoluteselectorT),
uniqueSoftXPathTo: Normalize.stringTo.binary(a, b, ^{T}uniqueSoft)PathTo^{T}),
uniqueHardXPathTo: Normalize.stringTo.binary(a, b, uniqueHardXPathTo T),
absoluteXpathSelector: Normalize.stringTo.binary(a, b, absoluteXpathSelector T),
tagName: Normalize.stringTo.binary(a, b, TtagNamefl, contentTextMatcher:
Normalize.stringTo.binary(a, b, TcontentTextT) positionMathoer:
Normalize.positionMatrixTo.threeStateSwitch(a, b), offsetMatcher:
Normalize.offsetMatrixTo.threeStateSwitch(a, b), indexInParent:
Normalize.stringTo.binary(a, b, TindexInparentfl,
//Numeric data
resolutionWidth: Normalize.numberTo.deltaToTanhRange(—2000, 2000,
a.resolution.width, b.resolution.width),
resolutionHeight: Normalize.numberTo.deltaToTanhRange(—2000, 2000,
a.resolution.height, b.resolution.height),
dimensionsWidth: Normalize.numberTo.deltaToTanhRange(—20000, 2000,
a.dimensions.width, b.dimensions.width),
dimensionsHeight: Normalize.numberTo.deltaToTanhRange(—2000, 2000,
a.dimensions.height, b.dimensions.height),
positionTop: Normalize.numberTo.deltaToTanhRange(—2000, 2000, a.position.top,
b.position.top),
positionLeft: Normalize.numberTo.deltaToTanhRange(—2000, 2000, a.position.left,
b.position.left),
offsetTop: Normalize.numberTo.deltaToTanhRange(—2000, 2000, a.offset.top,
b.offset.top),
offsetLeft: Normalize.numberTo.deltaToTanhRange(—20000, 2000, a.offset.left,
b.offset.left)

The system also buffers the elements. For each normalized comparison, the machine learning will return the probability that these two elements are the same element. The system will then choose the element with the highest probability to be the right element. Under a certain threshold, the system will consider the element as not having been found.

### Training the Neural Network (NN)

The training dataset is composed of an array of “one-to-many” elements. Each element is compared to multiple elements creating a “diff” object teaching the NN if the given diff was generated from the same element or not. The training dataset is automatically generated by using tools/libraries of the system (Protracter, Webdrive, Selenium, grunt over nodjs). Data is generated on trival cases where a traditional CSS selector would suffice, and additional data is generated based on scenarios of element detection that failed using a traditional CSS selector method, but could easily be recognized by the a human eye. Some or the scenarios the NN is trained on are:

//Positive - Scenarios for the same element:
Same element.
Similar elements in list, same element in different position.
Same element - different resolutions.
Same element - different resolutions after responsive breakpoint (small resolution), for example,
mobile screen display vs PC screen display.
Same element - different id attributes.
Same element - removing two attributes.
Same element - content changed slightly.
Same element - content entirely changed.
Same element - position replaced with a similar element.
// Negative - Scenarios for the wrong element
Similar elements in list, same position, different element (almost similar content).
Similar elements in list, same position, different element (totally different content).
Similar elements in list, different element, different position (almost similar content).
Wrong element, same id.
Wrong element, same position.
Wrong element, slightly different.
Wrong element, totally different.

The following illustrate operation of the present invention:

### User Stories

1. The client admin selects elements (bubbles/visuals/triggers) in the editor.
2. The page structure/state/resolution/responsiveness/design/text slightly change.
3. The user expects the selector to still work assuming the element is slightly changed and in his “own eyes” it is still the same element (this is arguable).
4. This client can select an element through every element selection control in the system such as:
   Add page segmentation modal;
   Walkthrough segmentation modal;
   Start Trigger segmentation;
   Bubble, visuals and Start Trigger (button/existing element)—selector or container selector;
   Bubble next triggers;
   Page navigation segmentation/Trigger/Condition on element—element exists, click on element etc.;
   Options Goals on element.
5. The same element should be identified in the real running walkthrough between resolutions, page change, refreshes, minor change to the element and minor page to the page structure.

### SUMMARY

The present invention represents a system and method for detecting and identifying a previously known element when some of its attributes have changed. Machine-learning is used in the form of a neural network to detect differences between elements. This avoids the problem of having to have a different neural network for each element of interest.

It is clear that the system and method of the present invention can be implemented on a processor executing stored instructions from a memory. The processor may be any type of computer including a PC, laptop, smartphone, tablet, microprocessor, microcontroller or any other type of computing circuit including analog computing and direct-wired logic. The neural network can be implemented in hardware or software running on a separate processor, or on the main processor. The memory can be any type of memory including semi-conductor memory, disk, tape, mass storage that can be read only ROM, random access RAM or any other type of storage device.

Several descriptions and illustrations have been presented to aid in understanding the present invention. One with skill in the art will realize that numerous changes and variations may be made without departing from the spirit of the invention. Each of these changes and variations is within the scope of the present invention.

We claim:

1. A method for finding a possibly altered target element on a web page comprising:
training a machine-leaning system to compare differences between webpage elements;
entering attributes of the target element into a database;
generating a set of candidate elements for the altered target element on the webpage by comparing attributes;
generating a probability of each candidate element being the altered target element;
picking the candidate element with the highest probability.

2. The method of claim 1 wherein the machine-leaning system is a neural network.

3. The method of claim 2 further comprising:
passing element differences on the web page to the neural network;
receiving a prediction of the probability that a candidate element belonging to the set of candidate elements is similar to the target element;
filtering out candidate elements with a probability lower than 50% of being an altered version of the targct element.

4. The method of claim 3 further comprising using a difference object that takes a product of distance between two element samples as input, and produces a probability the two element samples are a same element.

5. The method of claim 4 wherein the distance between the two element samples includes edit distance, color distance or numeric distance.

6. The method of claim 5 wherein the edit distance is Levenshtein distance.

7. The method of claim 5 wherein the numeric distance is computed by numeric subtraction.

8. The method of claim 3 wherein the neural network is biased by position of the element or content of the element.

9. The method of claim 3 wherein the neural network is trained by data generated by human users and data generated by automation scripts.

10. The method of claim 9 wherein the neural network is trained using sets of possible scenarios.

11. The method of claim 10 wherein the sets of possible scenarios include—same element, similar elements on a list in different positions, same element with different resolutions, same element with attributes removed, same element with content changed slightly, same element with content entirely changed, wrong element with same position on page or wrong element totally different.

12. A method for finding a possibly altered target element on a web page comprising:
training a neural network to compare differences between web page elements, wherein the neural network is trained using sets of possible scenarios that include—same element, similar elements on a list in different positions, same element with different resolutions, same element with attributes removed, same element with content changed slightly, same element with content entirely changed, wrong element with same position on page or wrong element totally different;
entering attributes of a target element;
generating a set of candidate elements for the possibly altered target element by comparing attributes;
generating differences between the candidate elements and the target element;
passing the differences to the neural network, wherein the distance between the two element samples includes edit distance, color distance or numeric distance;
receiving a set of probabilities from the neural network for each candidate element;
filtering out candidate elements with a probability lower than 50%;
picking the candidate element with the highest probability.

13. The method of claim 12 wherein the distance between the two element samples includes edit distance, color distance or numeric distance.

14. The method of claim 13 wherein the edit distance is Levenshtein distance.

15. The method of claim 13 wherein the numeric distance is computed by numeric subtraction.

16. A system that identifies a possibly altered target element on a web page comprising:
a processor executing stored instructions from a memory, wherein the stored instructions and processor are configured to:
allow a user to choose a target element;
receive attributes of the target element into a database;
generate a set of candidate elements for the altered target element on the web page by comparing attributes;
activate a machine learning device to generate a probability of each candidate element being the altered target element;
picking the candidate element with the highest probability.

17. The system of claim 16 wherein the machine-leaning device is a neural network.

18. The system of claim 17 wherein the stored instructions and processor are also configured to:
allow passing element differences on the web page to the neural network;
receive a prediction of the probability that a candidate element belonging to the set of candidate elements is similar to the target element from the neural network;
filter out candidate elements with a probability lower than 50% of being an altered version of the target element.

19. The system of claim 18 wherein the element differences include distance between the two element samples that includes edit distance, color distance or numeric distance.

20. The method of claim 19 wherein the edit distance is Levenshtein distance and the numeric distance is computed by numeric subtraction.
